(19) United States
(12) Patent Application Publication
(10) Pub. No.: US 2024/0242619 A1
(43) Pub. Date: Jul. 18, 2024

(54) AN APPARATUS AND METHOD FOR GENERATING A VIABILITY COACHING PLAN

(71) Applicant: C&J Innovations, LLC, Dallas, TX (US)

(72) Inventors: Colleen Bowler, Dallas, TX (US); Jeanne Hurlbert, Dallas, TX (US)

(73) Assignee: C&J Innovations, LLC, Dallas, TX (US)

(21) Appl. No.: 18/096,360

(22) Filed: Jan. 12, 2023

(51) Int. Cl. G09B 5/02

(52) U.S. Cl. CPC G09B 5/02

(57) ABSTRACT

an apparatus for generating a viability coaching plan, wherein the apparatus includes at least a processor and a memory communicatively connected to the at least a processor containing instructions configuring the at least a processor to receive a user profile from a user, determine an expansion plan as a function of the user profile, determine a walkaway plan as a function of the user profile, and generate a viability coaching plan as a function of the expansion plan and the walkaway plan.

### FIELD OF THE INVENTION

The present invention generally relates to the field of solution simulation and automation. In particular, the present invention is directed to an apparatus and method for generating a viability coaching plan.

### BACKGROUND

Current systems being used in finance consulting utilize a plurality of tables and a static set of assumptions. Financial advisors' understanding of client priorities lags behind clients' shift in priorities, creating a gap between the client's need and the financial advisors' assumed needs. Additionally, the scope of the financial advisor's role has transcended the financial realm to encompass a plurality of aspects of clients' lives, such as clients' emotional well-being. Current solutions lack a way to gain understanding of both financial and non-financial well-being and to track how it changes over time. A robust solution is needed to simulate a positive financial outcome with greater accuracy and a reasonable time frame.

### SUMMARY OF THE DISCLOSURE

In an aspect, an apparatus for generating a viability coaching plan, wherein the apparatus includes at least a processor and a memory communicatively connected to at least a processor, wherein the memory-containing instructions configuring at least a processor to receive a user profile from a user, determine an expansion plan as a function of the user profile, determine a walkaway plan as a function of the user profile, and generate a viability coaching plan as a function of the expansion plan and the walkaway plan.

In another aspect, a method for generating a viability coaching plan, wherein the method includes receiving, by at least a processor, a user profile from a user, determining, by at least a processor, an expansion plan as a function of the user profile, determining, by at least a processor, a walkaway plan as a function of the user profile, and generating, by the at least a processor, a viability coaching plan as a function of the expansion plan and the walkaway plan.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for generating a viability coaching plan;

FIG. 2 is a block diagram of an exemplary embodiment of a machine-learning module;

FIG. 3 is a block diagram illustrating an exemplary embodiment of a neural network;

FIG. 4 is a block diagram illustrating an exemplary embodiment of a node in a neural network;

FIG. 5 is a schematic diagram illustrating an exemplary embodiment of a fuzzy inferencing system; and

FIG. 6 is a schematic diagram of an exemplary embodiment of a method of generating a viability coaching plan; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for generating a viability coaching plan, wherein the apparatus includes at least a processor and a memory communicatively connected to the processor, wherein the memory containing instructions configuring the processor to receive a user profile from a user, determine an expansion plan as a function of the user profile, determine a walkaway plan as a function of the user profile, and generate a viability coaching plan as a function of the expansion plan and the walkaway plan. Exemplary embodiments illustrating aspects of the present disclosure are described below in the context of several specific examples.

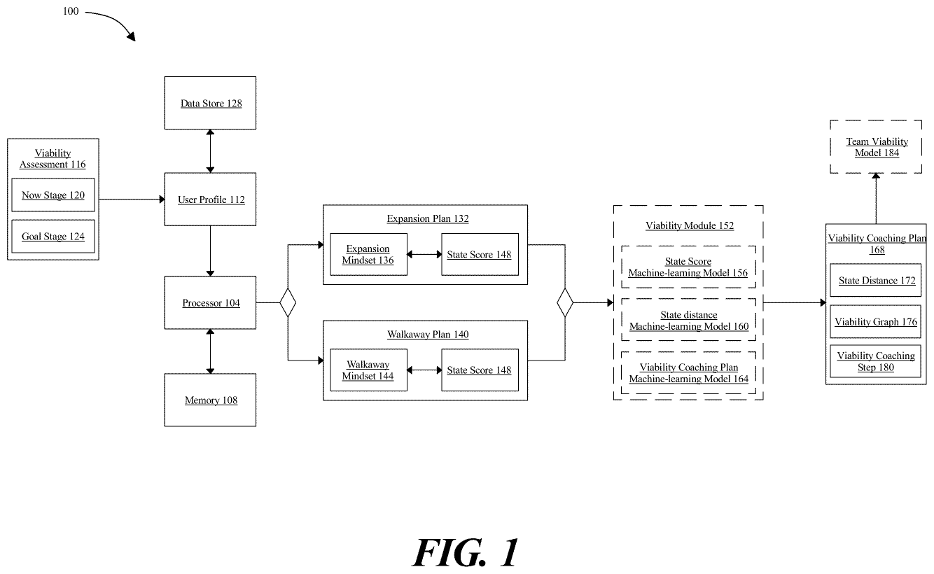

Referring now to FIG. 1, an exemplary embodiment of an apparatus 100 for generating a viability coaching plan is illustrated. Apparatus 100 may include a processor 104 and a memory 108 communicatively connected to the processor 104. Memory 108 includes a plurality of instructions configuring the processor to do various tasks, as described below. Processor 104 may include any computing device as described in this disclosure, including without limitation a microcontroller, microprocessor, digital signal processor (DSP) and/or a system on a chip (SoC), as described in this disclosure. Computing devices may include, be included in, and/or communicate with a mobile device, such as a mobile telephone or smartphone. Processor 104 may include a single computing device operating independently, or may include two or more computing devices operating in concert, in parallel, sequentially, or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card or a LAN card), a modem, and any combination thereof. Examples of a network include, but are not limited to, a wide area network (e.g., the Internet, an enterprise network), a local area network (e.g., a network associated with an office, a building, a campus or another relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices that may operate in parallel, in series, redundantly, or in any other manner used for distribution of tasks or memory between computing devices. Processor 104 may be implemented using a “shared nothing” architecture in which data are cached at the worker or in an embodiment; this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively, using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively-addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, processor 104 may perform determinations, classification, and/or analysis steps, methods, processes, or the like, as described in this disclosure using machine-learning processes. A “machine-learning process,” as used in this disclosure, is an automated process that uses a body of data known as “training data” and/or a “training set” (described further below in this disclosure) to generate an algorithm that will be performed by a processor 104/module to produce outputs given data provided as inputs; this is in contrast to a non-machine-learning software program in which the commands to be executed are determined in advance by a user and written in a programming language. Machine-learning processes may utilize supervised, unsupervised, lazy-learning processes and/or neural networks, described further below.

With continued reference to FIG. 1, as used in this disclosure, “communicatively connected” means connected by way of a connection, attachment, or linkage between two or more relata, which allows for reception and/or transmittance of information between them. For example, and without limitation, this connection may be wired or wireless, direct, or indirect, and between two or more components, circuits, devices, apparatuses, and the like, which allows for reception and/or transmittal of data and/or signal(s) between them. Data and/or signals may include, without limitation, electrical, electromagnetic, magnetic, video, audio, radio and microwave data and/or signals, combinations thereof, and the like, among others. A communicative connection may be achieved, for example and without limitation, through wired or wireless electronic, digital, or analog communication, either directly or by way of one or more intervening devices or components. Further, communicative connection may include electrically coupling or connecting at least an output of one device, component, or circuit to at least an input of another device, component, or circuits—for example, and without limitation, via a bus or other facility for intercommunication between elements of a computing device. Communicative connecting may also include indirect connections via, for example and without limitation, wireless connection; radio communication; a low-power wide area network; optical communication; magnetic, capacitive, or optical coupling; and the like. In some instances, the terminology “communicatively coupled” may be used in place of “communicatively connected” in this disclosure.

With continued reference to FIG. 1, processor 104 is configured to receive a user profile 112 from a user. As used in this disclosure, “receive” means to accept, collect, or otherwise receive input from a user and/or a device. As used in this disclosure, a “user” may include an individual, a family, an enterprise, and/or other groups of people. As used in this disclosure, “user profile” is a collection of data and/or information about a plurality of user-related data, wherein the user-related information is related to a user. In an embodiment, a user profile and/or user-related data may be obtained using a user device associated with a user. A “user device,” for the purpose of this disclosure, is any additional computing device—such as a mobile device, laptop, desktop computer, or the like. In a non-limiting embodiment, user device may be a computer and/or smart phone operated by a user in a remote location. User devices may include, without limitation, a display; the display may include any display as described in the entirety of this disclosure, such as a light emitting diode (LED) screen, liquid crystal display (LCD), organic LED, cathode ray tube (CRT), touch screen, or any combination thereof. In a non-limiting embodiment, a user device may include a visual interface configured to display any information from apparatus 100 and/or computing device. A visual interface, as disclosed here, will be described in further detail below. In some embodiments, user-related data may be in various format described below. Additionally, or alternatively, user-related data may be present in any data structure described below in this disclosure. In an exemplary embodiment and without limitation, user-related data may include any personal information related to the user. In some cases, personal information may include, without limitation, a user's name, age, gender, identification, profession, experience in profession, geographical information, family information, employer, and the like. Additionally, or alternatively, user-related data may also include any finance information related to a user. In exemplary embodiments, finance information may include, without limitation, assets, income, expenses, debts, and the like. Additionally, or alternatively, user-related data may include any health information related to a user. In exemplary embodiments, health information may include, without limitation, wellness, insurance, medical records, disease records, lifestyle, and the like. In a non-limiting example, processor 104 may receive a user profile 112 in a text file format, wherein the user profile 112 may include a user's personal information such as, without limitation, the user's name, age, gender, home address, and the like

With continued reference to FIG. 1, in some embodiments, user profile 112 may include user-related data associated with a user's expansion. As used in this disclosure, an “expansion” is a category of data that contains information related to user's accumulation. For example, accumulation may include the collection of either tangible or nontangible objects such as, without limitation, knowledge, assets, experience, and the like. In some cases, expansion may include information such as, without limitation, a user's financial goals, health goals, career goals, and the like. In a non-limiting example, user profile 112 may include a user's expansion, containing information related to the user's financial goals—for instance, a user's expected income and/or savings after five years. In some embodiments, user profile 112 may also include user-related data associated with a user's walkaway. As used in this disclosure, a “walkaway” is a category of data that contains information related to a user's retirement. In some cases, walkaway may include information such as, without limitation, a user's enrollment in a retirement program, a retirement account, retirement age, and the like. In a non-limiting example, user profile 112 may include a user's walkaway, containing information related to a user's retirement account—for instance, an amount of savings in the account.

With continued reference to FIG. 1, in some embodiments, user profile 112 and/or any data/information described in this disclosure may be present as a vector. As used in this disclosure, a “vector” is a data structure that represents one or more quantitative values and/or measures of home resource data. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, has an identity element that is distributive with respect to vector addition, and is distributive with respect to field addition. Each value of n-tuple of values may represent a measurement or other quantitative value associated with a given category of data, or attribute, examples of which are provided in further detail below. A vector may be represented, without limitation, in n-dimensional space using an axis per category of value represented in n-tuple of values, such that a vector has a geometric direction characterizing the relative quantities of attributes in the n-tuple, as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar and more different where their directions are more divergent—for instance as measured using cosine similarity, computed using a dot product of two vectors. However, vector similarity may alternatively or additionally be determined using averages of similarities between like attributes, or any other measure of similarity suitable for any n-tuple of values, or aggregation of numerical similarity measures for the purposes of loss functions, as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿ aᵢ²}, where aᵢ is attribute number I of the vector. Scaling and/or normalization may function to make vector comparison independent of absolute quantities of attributes, while preserving any dependency on similarity of attributes.

With continued reference to FIG. 1, in some embodiments, a user profile 112 and/or any other data/information described in this disclosure may be present as a dictionary. As used in this disclosure, a “dictionary” is a data structure containing an unordered set of key value pairs. In this disclosure, a “key value pair” is a data representation of a data element such as, without limitation, entries of user-related data, any other information within user profile 112, and the like. In some cases, dictionary may be an associative memory, or associative arrays, or the like. In a non-limiting example, a dictionary may be a hash table. In an embodiment, kay value pairs may include a unique key, wherein the unique kay may associate with one or more values. In another embodiment, key value pairs may include a value, wherein the value may associate with a single key. In some cases, each key value pair in a set of key value pairs in a dictionary may be separated by a separator, wherein the separator is an element for separating two key value pairs. In a non-limiting example, a separator may be a comma in between each key value pair in a plurality of key value pairs within a dictionary. In another non-limiting example, a dictionary may be expressed as “{first key value pair, second key value pair},” wherein the first key value pair and the second key value pair may be separated by a comma separator and wherein both the first key value pair and the second key value pair may be expressed as “first/second key: first/second value.” In a further non-limiting example, user profile 112 may be present as a dictionary: “{x: A, y: B},” wherein x may be a first entry corresponding to user-related data from first user A and y may be a second entry may correspond to a second set of user-related data from B. Additionally, or alternatively, a dictionary may include a term index, wherein the term index is a data structure to facilitate fast lookup of entries within a dictionary (i.e., index). In some cases, without limitation, term index may use a zero-based indexing, wherein the zero-based indexing may configure a dictionary to start with index 0. In some cases, without limitation, a term index may use one-based indexing, wherein the one-based indexing may configure a dictionary to start with index 1. In other cases, without limitation, a term index may use a n-based indexing, wherein the n-based indexing may configure a dictionary to start with any index from 0 to n. Further, a term index may be determined/calculated using one or more hash functions. As used in this disclosure, a “hash function” is a function used to map data of arbitrary size to a fixed-size value. In some cases, a fixed-size value may include, but is not limited to, hash value, hash code, hash digest, and the like. In a non-limiting example, user profile 112 may be present as a dictionary containing a plurality of hashes generated using hash function such as, without limitation, an identity hash function, a trivial hash function, a division hash function, word length folding, and the like, wherein each hash of a plurality of hashes may represent a single entry of user-related data within user profile 112.

With continued reference to FIG. 1, in other embodiments, user profile 112 and/or any other data/information described in this disclosure may be present as any other data structure such as, without limitation, tuple, single dimension array, multi-dimension array, a list, linked list, queue, set, stack, dequeue, stream, map, graph, tree, and the like. In some embodiments, user profile 112 and/or any other data/information described in this disclosure may be present as a combination of more than one above data structure, as described above. In a non-limiting example, user profile 112 may include a dictionary of lists. As will be appreciated by persons having ordinary skill in the art, after having read the entirety of this disclosure, the foregoing list is provided by way of example and other data structures can be added as an extension or improvements of apparatus 100 disclosed herein. In some embodiments, without limitation, data structure may include an immutable data structure, wherein the immutable data structure is a data structure that cannot be changed, modified, and/or updated once the data structure is initialized. In other embodiments, without limitation, data structure may include a mutable data structure, wherein the mutable data structure is a data collection that can be changed, modified, and/or updated once the data structure is initialized. Additionally, or alternatively, user profile 112 and/or any other data/information described in this disclosure may include an electric file format such as, without limitation, txt file, JSON file, XML file, word document, pdf file, excel sheet, image, video, audio, and the like.

With continued reference to FIG. 1, in some cases, the data within a data structure described above may be sorted in a certain order such as, without limitation, ascending order, descending order, and the like. In a non-limiting example, sorting data within user profile 112 may include using a sorting algorithm. In some cases, a sorting algorithm may include, but is not limited to, selection sort, bubble sort, insertion sort, merge sort, quick sort, heap sort, radix sort, and the like. In a non-limiting example, user-related data within user profile 112 may be sorted in alphabetical order. As will be appreciated by persons having ordinary skill in the art, after having read the entirety of this disclosure, the foregoing list is provided by way of example and other sorting algorithms can be added as an extension or improvement of apparatus 100 disclosed herein.

With continued reference to FIG. 1, in some embodiments, receiving user profile 112 may include accepting a viability assessment 116 from the user. As used in this disclosure, a “viability assessment” is a set of questions that asks for user related information. In some embodiments, each question within the set of questions of viability assessment 116 may include at least one answer and/or non-answer (such as leaving the question blank). In some cases, a question within viability assessment 116 may include a question that provides a user with an option of selecting a selection from a plurality of response options. In a non-limiting example, viability assessment 116 may include a plurality of multiple-choice questions, wherein each multiple-choice question may include a plurality of response options for the user to select. User selected response option may be the answer to the question. In other embodiments, a question within viability assessment 116 may include a free user input as an answer. As used in this disclosure, a “free user input” is an input that is not defined, or otherwise constrained, by existing answers to a corresponding question. In a further non-limiting embodiment, answers to a question within viability assessment 116 may include text input in addition to existing choice selections. In some embodiments, viability assessment 116 may include questions in a plurality of categories such as, without limitation, a plurality of expansion mindsets 136, a plurality of walkaway mindsets 144, and the like. Expansion mindsets and walkaway mindsets disclosed here will be described in further detail below. In a non-limiting example, viability assessment 116 may include a first set of questions containing questions related to a user's expansion (described above) and a second set of questions containing questions related to user's walkaway (described above). In some embodiments, viability assessment 116 may include a plurality of stages containing a now stage 120 and a goal stage 124. As used in this disclosure, a “stage” is a point, period, or other type of step in in a viability assessment 116. In a non-limiting example, questions may be asked at plurality of stages. As used in this disclosure, a “now stage” is a time period corresponding to a plurality of questions within viability assessment 116 that ask about a user's current situation. As used in this disclosure, a “goal stage” is a time period in which a plurality of questions within viability assessment 116 asks about user's objective. In some embodiments, a plurality of stages may be arranged in chronological order. In a non-limiting example, viability assessment 116 may include a question regarding the user's expansion, wherein the question may include a now stage 120; for instance, tapping the foundation mindset by exploring whether they have the 5 key protections (life insurance, disability insurance, long-term care insurance, a will and/or trust, and savings). The question may further include a goal stage 124; for instance, tapping the foundation mindset by exploring where the user wants to be regarding having the 5 key protections (life insurance, disability insurance, long-term care insurance, a will and/or trust, and savings). In another non-limiting example, viability assessment 116 may include a question regarding the user's walkaway wherein the question may include a now stage 120; for instance, tapping the wellness mindset by exploring the extent to which the user focuses on healthy habits, such as exercising or watching what they eat” A question may further include a goal stage 124; for instance, tapping the goal stage of the wellness mindset by exploring the degree to which the user wants to focus on health habits, such as exercising and watching what they eat. A plurality of questions may be selected by processor 104 from a question bank. In a non-limiting example, a plurality of questions may be stored in data store 128. In a non-limiting embodiment, viability assessment 116 may be generated by selecting one or more questions from data store 128. In a non-limiting example, viability assessment 116 may include a fixed format such as a user self-evaluation containing a plurality of textual questions to the user. In a non-limiting embodiment, viability assessment 116 may be in other format such as, without limitation, survey, interview, report, events monitoring, and the like thereof. In a further non-limiting embodiment, viability assessment 116 may include a data submission of one or more documentations from the user. As used in this disclosure, a “data submission” is an assemblage of data provided by the user as an input source. In a non-limiting example, data submission may include user uploading one or more user profiles to processor 104. As used in this disclosure, a “documentation” is a source of information. In some cases, documentation may include an electronic document, such as, without limitation, txt file, JSON file, word document, pdf file, excel sheet, image, video, audio, and the like thereof. In a non-limiting example, documentation may include user profile 112, and may be input source of data submission for further processing. Further processing may include any processing step described below in this disclosure. Viability assessment 116 may be accepted through visual interface described below. In a non-limiting example, user may submit viability assessment 116 through a submit button on the visual interface, wherein the submit button may be configured to submit a plurality of answers corresponding to a plurality of questions within the viability assessment 116 and/or request to continue the viability assessment 116 to processor 104.

With continued reference to FIG. 1, in some embodiments, user profile 112 may be received and/or stored in a data store 128 such as, without a limitation, a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records, as described above. Data entries in a database may be flagged with or linked to one or more additional elements of information, which may be reflected in data entry cells and/or in linked tables, such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, processor 104 is further configured to determine an expansion plan 132 as a function of user profile 112. As used in this disclosure, an “expansion plan” is an evaluation of user's expansion within user profile 112. In some embodiments, expansion plan 132 may be determined based on answers to questions regarding to a user's expansion within viability assessment 116. In some embodiments, expansion plan 132 may include a plurality of expansion mindsets 136 associated with a plurality of state scores 148. As used in this disclosure, an “expansion mindset” is a set of attitudes for improving a user's expansion, as described above. Improving a user's expansion includes increasing a user's joy and quality of life during the user's development (i.e., accumulation) phase, helping the user navigate their future plans, and the like. In a non-limiting example, a plurality of expansion mindsets 136 may include a readiness mindset, wherein the readiness mindset is a set of attitudes related to a user's available funds for unexpected expenses. In a non-limiting example, a plurality of expansion mindsets 136 may include a foundation mindset, wherein the foundation mindset is a set of attitudes related to financial protections for protecting a user and the user's family. Protections may include a will and/or trust, savings, assets that can be liquidated, life insurance, disability insurance, long-term care insurance, and the like. In a non-limiting example, a plurality of expansion mindsets 136 may include a resource mindset, wherein the resource mindset is a set of attitudes related to a user's proactive tracking of expenses. In a non-limiting example, a plurality of expansion mindsets 136 may include a wellness mindset, wherein the wellness mindset is a set of attitudes related to a user's prioritization of health and fitness. In a non-limiting example, a plurality of expansion mindsets 136 may include a caring mindset, wherein the caring mindset is a set of attitudes related to steps taken by user to ensure that persons close to user, such as the user's family, can access documents and accounts related to the user. In a non-limiting example, a plurality of expansion mindsets 136 may include an accumulation mindset, wherein the accumulation mindset is a set of attitudes related to a user's plan for saving money to achieve one or more life goals. In a non-limiting example, a plurality of expansion mindsets 136 may include a walkaway mindset, wherein the walkaway mindset is a set of attitudes related to a user's enrollment in at least a retirement account. In a non-limiting example, plurality of expansion mindsets 136 may include a partnership mindset, wherein the partnership mindset is a set of attitudes related to a user's willingness to work with a financial advisor in partnership.

With continued reference to FIG. 1, processor 104 is further configured to determine a walkaway plan 140 as a function of user profile 112. As used in this disclosure, a “walkaway plan” is an evaluation of a user's walkaway within user profile 112. In a non-limiting example, determining a walkaway plan 140 may include determining walkaway plan 140, in a manner similar to determining expansion plan 132. Walkaway plan 140 may be determined based on answers to questions regarding a user's walkaway within viability assessment 116. In some embodiments, a walkaway plan 140 may include a plurality of walkaway mindsets 144 associated with a plurality of state scores 148. As used in this disclosure, a “walkaway mindset” is a set of attitudes for improving a user's walkaway, as described above. Improving a user's walkaway includes increasing the user's joy and quality of life after retirement, helping the user to accomplish their life goals, and the like. In a non-limiting example, a plurality of walkaway mindsets 144 may include a longevity mindset, wherein the longevity mindset is a set of attitudes related to a user's plan for receiving care once the user is no longer able to care for themselves. In a non-limiting example, a plurality of walkaway mindsets 144 may include an income mindset, wherein the income mindset is a set of attitudes related to a user's planning for income after walking away from their current career/employment. In a non-limiting example, a plurality of walkaway mindsets 144 may include a purpose mindset, wherein the purpose mindset is a set of attitudes related to a user's long-term purpose, or “next chapter,” after walking away from their current career/employment. Additionally, or alternatively, a plurality of walkaway mindsets 144 may include one or more shared mindsets from a plurality of expansion mindsets 136, wherein each shared mindset may be a set of attitudes that are common to both a user's expansion and the user's walkaway. In a non-limiting example, a plurality of expansion mindsets 136—such as, without limitation, readiness mindset, wellness mindset, foundation mindset, caring mindset, and partnership mindset—may be shared with walkaway mindsets 144.

With continued reference to FIG. 1, as used in this disclosure, a “state score” is a quantitative measurement of a user's status in expansion mindset 136 and/or walkaway mindset 144. In some embodiments, a state score of 148 may be on a scale of x to y, wherein x may represent a minimum state score and y may represent a maximum state score. In a non-limiting example, a low state score may indicate a user has less strength in a given mindset, while a high state score may indicate that a user has greater strength in the given mindset. In some embodiments, state score 148 may be determined as a function of answers to questions within viability assessment 116. In a non-limiting example, viability assessment 116 may include a question related to user's expansion: “how often do you use a cash flow tracker?” Question may include four answers: “never,” “occasionally,” “frequently,” and “at least once a month.” Each answer may be associated with a range of state scores. Answer “never” may associate with a subrange of state scores from x₁ to y₁. Answer “occasionally” may associate with a subrange of state scores from x₂ to y₂. Answer “frequently” may associate with a subrange of state scores from x₃ to y₃. Answer “at least once a month” may associate with a subrange of state scores from x₄ to y₄. In another non-limiting example, viability assessment 116 may include a question related to a user's walkaway: “Do you have a plan in place for care if you are no longer able to care for yourself?” Question may include four response options: “no plan,” “rely on family or friends,” “have some financial provisions for long-term care,” and “have long-term care insurance or sufficient fund.” Each answer may associate with a range of state scores. Answer “no plan” may associate with a subrange of state scores from x₁ to y₁. Answer “rely on family or friends” may associate with a subrange of state scores from x₂ to y₂. Answer “have some financial provisions for long-term care” may associate with a subrange of state scores from x₃ to y₃. Answer “have long-term care insurance or sufficient fund” may associate with a subrange of state scores from x₄ to y₄. Additionally, or alternatively, state score 148 may include a current state score and a target state score. As used in this disclosure, a “current state score” is a state score of expansion mindset 136 or walkaway mindset 144 at now stage 120. As used in this disclosure, a “target state score” is a state score of expansion mindset 136 or walkaway mindset 144 at goal stage 124. In a non-limiting example, current state score may be determined as a function of answer to questions within viability assessment 116 at now stage 120. Target state score may be determined as a function of answer to questions within viability assessment 116 at goal stage 124. Further, state score 148 may include a composite state score, wherein the composite state score is an overall state score representing expansion plan 132 and/or walkaway plan. In a non-limiting example, composite state score may be determined by calculating the sum of a plurality of state scores associated with a plurality of expansion mindsets 136 and/or a plurality of walkaway mindsets 144.

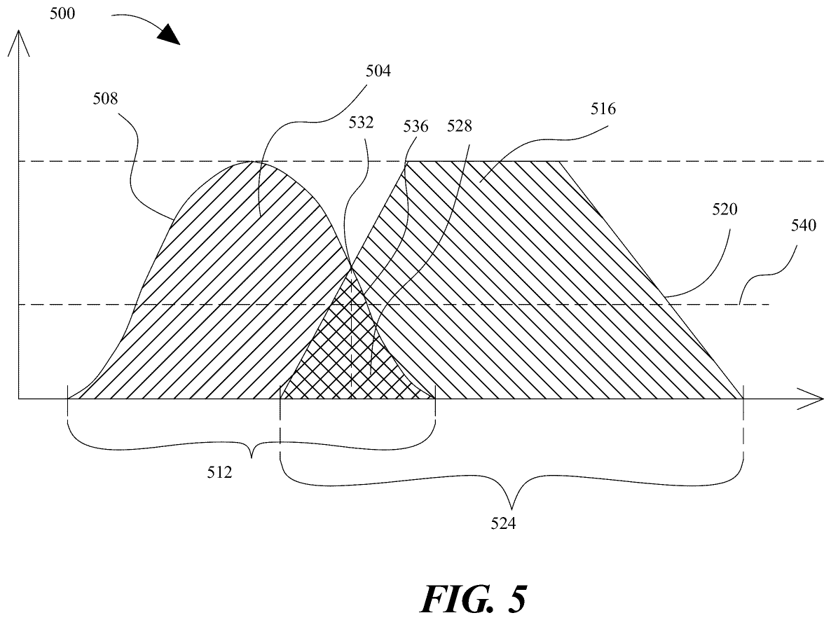

With continued reference to FIG. 1, in some embodiments, state score 148 may be determined using fuzzy logic. A machine-earning model, such as state score machine-learning model 156 described in further detail below, may be implemented as a fuzzy inferencing system. described in more detail with reference to FIG. 5. As used in the current disclosure, a “fuzzy inference” is a method that interprets the values in the input vector (e.g., a user profile) and, based upon a set of rules, assigns the values to the output vector. A fuzzy set may also be used to show a degree of match between fuzzy sets may be used to rank one resource against another. For instance, if both user profile 112 and state score 148 have fuzzy sets, state score 148 may be determined by having a degree of overlap exceeding a predetermined threshold.

With continued reference to FIG. 1, in some embodiments, processor 104 may determine state score 148 using a using a lookup table. A “lookup table,” for the purposes of this disclosure, is an array of data that maps input values to output values. A lookup table may be used to replace a runtime computation with an array indexing operation. In another non-limiting example, a state score lookup table may be able to correlate user profile 112 such as, without limitation, user-related data and the like to one or more state scores 148. Processor 104 may be configured to “lookup” one or more user profiles 112 in order to find a corresponding state score 148. In other examples, a state score lookup table may be able to correlate viability assessment 116—in particular, an answer to a question within viability assessment 116—to one or more state scores 148. Processor 104 may be configured to lookup one or more answers to find a corresponding state score 148.

With continued reference to FIG. 1, processor 104 may use a machine-learning module, such as viability module 152, to implement one or more algorithms or generate one or more machine-learning models—such as state score machine-learning model 156—to determine one or more state scores 148. However, the machine-learning module is exemplary and may not be necessary to generate one or more machine-learning models and perform any machine-learning described herein. In one or more embodiments, one or more machine-learning models may be generated, using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories/values of data elements. Exemplary inputs and outputs may come from data store 128, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated with each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories or values of data elements by, for example, associating the data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Viability module 152 may be used to generate a state score machine-learning model and/or any other machine-learning model, such as state distance machine-learning model 160, viability coaching plan machine-learning model 164, and the like described below, using training data. State score machine-learning model 156 may be trained by correlated inputs and outputs of training data. Training data may be datasets that have already been converted from raw data whether manually, by machine, or by any other method. Training data may include previous outputs, such that state score machine-learning model 156 iteratively produces outputs. State score machine-learning model 156 may output converted data based on input of training data, using a machine-learning process. In an embodiment, determining expansion plan 132 and/or walkaway plan 140 containing plurality of expansion mindsets 136 and/or plurality of walkaway mindsets 144 may include determining a state score 148 for each expansion mindset and/or walkaway mindset based on user profile 112 using a machine-learning model, such as state score machine-learning model 156 generated by viability module 152. State score machine-learning model 156 may be trained by training data, discussed in further detail below, such as state score training data. State score training data may be stored in data store 128.

With continued reference to FIG. 1, determining state score 148 on each expansion mindset and/or walkaway mindset, based on a user profile using a machine-learning model, may include receiving state score training data. In an embodiment, state score training data may include a plurality of user profiles 112 that are each correlated with a plurality of state scores 148. For example, state score training data may be used to show that user profiles may indicate a particular strength on plurality of expansion mindsets 136 and/or walkaway mindsets 144. Determining state score 148, using a machine-learning model, may further include training a state score machine-learning model 156 as a function of state score training data. Further, determining state score 148 using a machine-learning model may also include determining one or more state scores 148, using trained state score machine-learning model 156.

With continued reference to FIG. 1, processor 104 is further configured to generate a viability coaching plan 168 as a function of expansion plan 132 and walkaway plan 140. As used in this disclosure, a “viability coaching plan” is a strategy that guides a user toward success in an expansion mindset and/or walkaway mindset. As used in this disclosure, an “expansion mindset” is an attitude affecting a user's expansion, as described above. As used in this disclosure, a “walkaway mindset” is an attitude toward affecting a user's walkaway, as described above. In a non-limiting example, viability coaching plan 168 may only include goals and/or corresponding strategies in an expansion mindset. In another non-limiting example, viability coaching plan 168 may only include goals and/or corresponding strategies in a walkaway mindset. In a further non-limiting example, viability coaching plan 168 may include combining a plurality of viability coaching plans; for instance, and without limitation, viability coaching plan 168 may combine a first viability coaching plan that focuses on an expansion mindset with a second viability coaching plan that focuses on the walkaway mindset described above. In this case, viability coaching plan 168 may include goals and/or corresponding strategies in an expansion mindset and walkaway mindset. In some embodiments, generating a viability coaching plan may include providing a visual interface configured to display viability coaching plan 168. As used in this disclosure, a “visual interface” is a form of interface that is visible to a user and allows users to interact with apparatus 100. In a non-limiting example, viability coaching plan 168 may be present graphically through a graphical user interface (GUI). In some embodiments, the visual interface may be configured to present user profile 112, viability assessment 116, expansion plan 132, walkaway plan 140, and the like. In a non-limiting example, a visual interface may be a web page displaying questions and corresponding response options of viability assessment 116. Processor 104 may receive user profile 112 while user interacts with visual interface.

With continued reference to FIG. 1, in some embodiments, viability coaching plan may include a viability graph 176. Viability graph 176 may be displayed through visual interface described above. As used in this disclosure, a “viability graph” is a diagram displaying one or more state scores 148 from expansion plan 132 and/or walkaway plan 140, within a viability coaching plan. In a non-limiting example, viability graph 176 may express a relationship between expansion plan 132, particularly a plurality of expansion mindsets 136 and plurality of state scores 148. In another non-limiting example, viability graph 176 may express a relationship between walkaway plan 140, a particularly plurality of walkaway mindsets 144 and a plurality of state scores 148. In some embodiments, viability graph 176 may include a line graph, wherein the line graph is a plot showing how information changes from one point to another, using a plurality of lines, wherein the point is an intersection of a first variable from a first entity and a second variable from a second entity. In some embodiments, without limitation, viability graph 176 may be expressed in a two-dimensional (2D) space, wherein the two-dimensional space may consist of a horizontal axis (x-axis) and a vertical axis (y-axis). In a non-limiting example, viability coaching plan may be visualized through a line graph in two-dimensional space, wherein vertical axis may represent a plurality of state scores 148 and horizontal axis may represent a plurality of expansion mindsets 136 and/or a plurality of walkaway mindsets 144. In other embodiments, without limitation, viability graph 176 may be expressed in a multi-dimensional space, wherein the multi-dimensional space may consist of a plurality of axes. Each axis or plurality of axes may represent a single mindset within a plurality of expansion mindsets 136 and/or plurality of walkaway mindsets 144, such as, without limitation, a readiness mindset, foundation mindset, resource mindset, wellness mindset, caring mindset, accumulation mindset, walkaway mindset, partnership mindset, longevity mindset, income mindset, purpose mindset, and the like. Additionally, or alternatively, viability graph 176 may include a plurality of line graphs, wherein each line graph of plurality of line graph may represent a relationship between two entities at a single stage. In a non-limiting example, viability graph 176 may include a first line graph representing a relationship between plurality of expansion mindsets 136/plurality of walkaway mindsets 144 and corresponding plurality of state scores 148 at now stage 120. A viability graph may further include a second line graph representing a relationship between a plurality of expansion mindsets 136, a plurality of walkaway mindsets 144, and a corresponding plurality of state scores 148 at goal stage 124. Further, viability graph 176 may include a plurality of viability graphs. In a non-limiting example, viability graph 176 may include a first viability graph for expansion plan 132 and a second viability graph for walkaway plan 140.

With continued reference to FIG. 1, in some embodiments, generating viability coaching plan 168 may include identifying a state distance 172 as a function of expansion plan 132 or walkaway plan 140. As used in this disclosure, a “state distance” is a distance between two state scores. State score may include any state score described in this disclosure. In some embodiments, state distance 172 may include distance between state score 148 at different stages. Stage may include any stage described above in this disclosure. In a non-limiting example, state distance 172 may include a distance between state score 148 from now stage 120 to goal stage 124; for instance, identifying the state distance 172 may include comparing a current state score with a target state score. Continuing the example, state distance 172 between current state score x and target state score y may be y−x. In another non-limiting example, expansion plan 132 and/or walkaway plan 140 may include a first state vector determined at now stage 120 and a second state vector determined at goal stage 124, wherein the first state vector and the second state vector are a plurality of state scores in vector data structure described above. Each state score 148 may be correlated with one of a plurality of expansion mindsets 136. Processor 104 may identify state distance 172 by calculating a vector distance as a function of first state vector and a second state vector. In other non-limiting example, identifying a state distance 172 may include identifying a distance between two lines in viability graph 176; for instance, a distance between one or more data points on a first line graph and one or more data points on a second line graph. In other embodiments, processor 104 may be configured to identify state distance 172 as a function of expansion plan 132 and walkaway plan 140, using a machine-learning model, such as state distance machine-learning model 160 generated by viability module 152. State distance machine-learning model 160 may be trained by training data, discussed in further detail below, such as state distance training data. State distance training data may be stored in data store 128, such as a database as described above.

With continued reference to FIG. 1, identifying state distance 172 as a function of expansion plan 132 and walkaway plan 140, using a machine-learning model, may include receiving state distance training data. In an embodiment, state distance training data may include a plurality of state score pairs that are each correlated to one of a plurality of state distance. As used in this disclosure, a “state score pair” is a set of state scores 148, wherein the set contains one or more state scores from one stage such as, without limitation, now stage 120, and one or more state scores from another stage such as, without limitation, goal stage 124. In a non-limiting example, state score pair may include a current state score paired with a target state score. For example, state distance training data may be used to show a plurality of state scores 148 and may indicate a particular state distance in between plurality of stages. In an exemplary embodiment, stage may be now stage 120, goal stage 124, and the like. Identifying state distance 172, using a machine-learning model, may further include training state distance machine-learning model 160 as a function of state distance training data. Further, identifying state distance 172, using a machine-learning model, may also include identifying state distance 172, using trained state distance machine-learning model 160.

With continued reference to FIG. 1, in some embodiments, viability coaching plan 168 may include a viability coaching step 180. As used in this disclosure, a “viability coaching step” is a recommendation, suggestion, or otherwise advice for enhancing a plurality of expansion mindsets 136 within expansion plan 132 and/or a plurality of walkaway mindsets 144 within walkaway plan 140. In some embodiments, viability coaching step 180 may include recommendations related to reducing state distance 172 for each expansion mindset 136 and/or walkaway mindset 144, described above. In some cases, recommendations within viability coaching step 180 may be different based on state distance 172. In a non-limiting example, expansion plan 132 of a user may include a high state distance in accumulation mindset, viability coaching plan 168, generated based on expansion plan 132, and may include viability coaching step 180, containing a recommendation for the user such as, without limitation: “gaining additional clarity on what you want to achieve and why you want to achieve it can prove motivating. Don't forget the ‘why,’ because when you begin to veer off track (which you probably will), the ‘why’ pulls you back to center—to what you really want.” In some embodiments, viability coaching step 180 may include recommendations related to current state score (i.e., state scores at now stage 120). Continuing the example, viability coaching step 180 may contain another recommendation for the user such as, without limitation: “You've made a great start in this mindset. To move closer to your goal, start by estimating as precisely as possible how much money you need for your goal and documenting how much you have already saved toward your goal.” Additionally, or alternatively, viability coaching plan 168 may be color coded. As used in this disclosure, “color coding” means marking objects with different colors as a means of identification. In some cases, objects may include, without limitation, viability coaching step 180, state distance 172, state score 148, expansion plan 132, plurality of expansion mindsets 136, walkaway plan 140, plurality of walkaway mindsets 144, and the like. In a non-limiting example, expansion mindset/walkaway mindset with a high state distance may be in color red. Expansion mindset/walkaway mindset with a medium state distance may be in color yellow. Expansion mindset/walkaway mindset with a low state distance may be in color green.

With continued reference to FIG. 1, in some embodiments, generating viability coaching plan 168 may include classifying expansion plan 132 and walkaway plan 140 to at least one viability coaching plan 168 for the user, using a machine-learning model, such as viability coaching plan machine-learning model 164 generated by viability module 152. viability coaching plan machine-learning model 164 may be trained by viability coaching plan training data, wherein the viability coaching plan training data may include a plurality of expansion plan 132 and walkaway plan as input correlated to a plurality of viability coaching plans as output. Dual-goal viability coaching plan viability coaching plan training data may be stored in data store 128, such as a database described above. For example, viability coaching plan training data may be used to show both expansion plan 132 and walkaway plan may indicate a particular viability coaching plan 168 for enhancing both plans. viability coaching plan may be any viability coaching plan described in this disclosure. Generating viability coaching plan 168 using a machine-learning model may further include training the viability coaching plan machine-learning model 164, as a function of viability coaching plan training data. Further, generating viability coaching plan 168, using a machine-learning model, may also include generating at least one viability coaching plan 168 using trained viability coaching plan machine-learning model 164.

With continued reference to FIG. 1, additionally, or alternatively, viability coaching plan machine-learning model 164 may include a classifier. A “classifier,” as used in this disclosure, is a machine-learning model, such as a mathematical model, neural net, or program, generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies data that are clustered together, found to be close under a distance metric as described below, or the like. Processor 104 and/or another device may generate a classifier, using a classification algorithm, defined as a process whereby a processor 104 derives a classifier from training data, such as viability coaching plan training data. Classification may be performed using, without limitation, linear classifiers such as without limitation logistic regression and/or naïve Bayes classifiers; nearest neighbor classifiers such as k-nearest neighbors classifiers; support vector machines; least squares support vector machines; fisher's linear discriminant; quadratic classifiers; decision trees; boosted trees; random forest classifiers; learning vector quantization; and/or neural network-based classifiers.

With continued reference to FIG. 1, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample features resemble training data. Classifying input data to one or more clusters and/or categories of features, as represented in training data, may be performed by representing both training data and input data in vector forms and using one or more measures of vector similarity to identify classifications within training data and to determine a classification of input data. A K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. A heuristic may include selecting some number of highest-ranking associations and/or training data elements.

With continued reference to FIG. 1, generating k-nearest neighbors algorithms may generate a first vector output containing a data entry cluster, generating a second vector output containing an input data, and calculating the distance between the first vector output and the second vector output, using any suitable norm, such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute. Examples are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions, as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿ aᵢ²}, where aᵢ is attribute corresponding to index i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, additionally, or alternatively, processor 104 may be further configured to generate a group viability model 184, configured to provide a group insight, wherein the group viability model 184 may include a plurality of viability coaching plans 168. As used in this disclosure, a “group viability model” is an application of viability coaching plan 168 in a group setting. In a non-limiting example, processor 104 may receive a plurality of user profiles 112 from a group, wherein the group may include a plurality of group members. Processor 104 may generate a viability coaching plan 168 for each team member, using any processing step described in this disclosure. As used in this disclosure, a “group insight” is an in-depth understanding of a group. In a non-limiting example, group insight may include the priority of tasks and/or goals of each group member. In some cases, tasks may include, without limitation, viability coaching step 180; for instance, providing group insight may include identifying one or more viability coaching step 180 for greatest state distance 172 within viability coaching plan 168, for each group member. In some embodiments, group viability model may include a comparison of a plurality of viability coaching plans 168. In a non-limiting example, group viability model may include a comparison matrix, wherein the comparison matrix may include a plurality of columns and a plurality of rows. Each column may represent a single expansion mindset or walkaway mindset within expansion plan 132 or walkaway plan 140. Each row may represent one team member. Elements of comparison matrix may include a state score 148. In some cases, each column of comparison matrix may further include a plurality of sub-columns representing a plurality of stages such as, without limitation, now stage 120, goal stage 124, and the like. Group viability model 184 may be used to identify weaknesses (e.g., element of comparison matrix with low state score) and/or strengths (i.e., element of comparison matrix with a high state score) among team members.

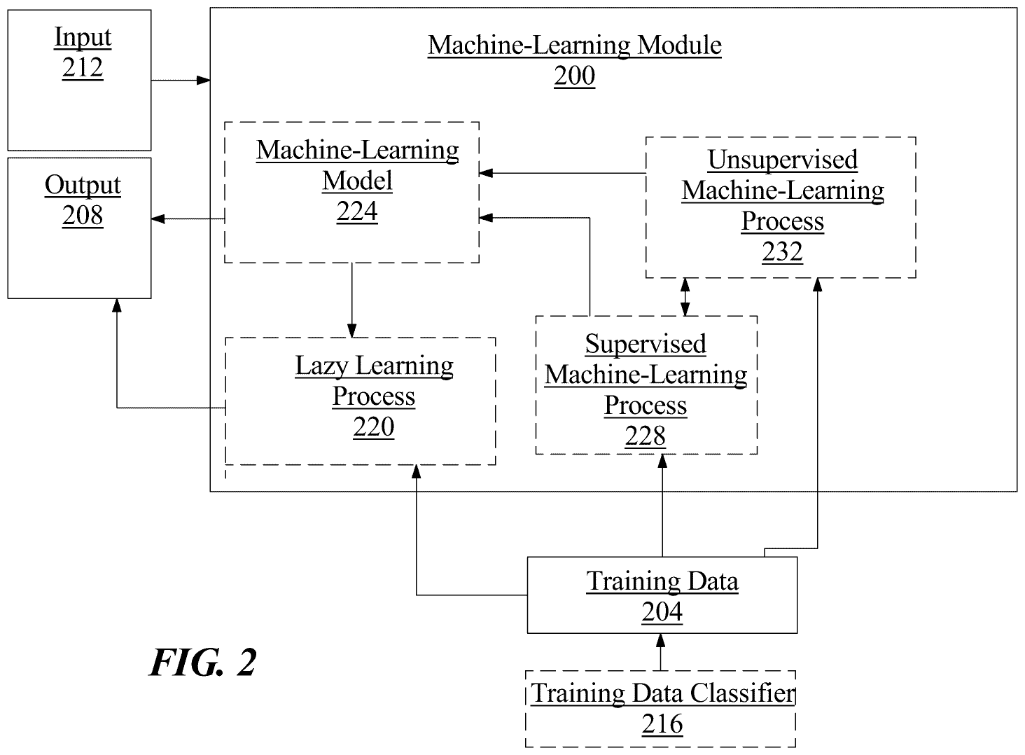

Referring now to FIG. 2, an exemplary embodiment of a machine-learning module 200 that may perform one or more machine-learning processes, as described in this disclosure, is illustrated. Machine-learning module may perform determinations, classification, and/or analysis steps, methods, processes, or the like as described in this disclosure using machine learning processes. Machine-learning process may use training data 204 to generate an algorithm that will be performed by processor 104/module to produce outputs 208 given data provided as inputs 212; this is in contrast to a non-machine learning software program where the commands to be executed are determined in advance by a user and written in a programming language. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data elements may tend to correlate to a higher value of a second data element belonging to a second category of data elements, indicating a possible proportional or other mathematical relationship linking values belonging to the two categories. Multiple categories of data elements may be related in training data 204, according to various correlations; correlations may indicate causative and/or predictive links between categories of data elements, which may be modeled as relationships, such as mathematical relationships, by machine-learning processes, as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length format, formats linking positions of data to categories such as comma-separated value (CSV) formats and/or self-describing formats, such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data, and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order. Such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms and/or automated association of data in the data entry with descriptors or into a given format. The ability to categorize data entries automatedly may enable the same training data 204 to be made applicable for two or more distinct machine-learning algorithms, as described in further detail below. Training data 204, used by machine-learning module 200, may correlate any input data, as described in this disclosure, to any output data as described in this disclosure.

Further referring to FIG. 2, training data may be filtered, sorted, and/or selected using one or more supervised and/or unsupervised machine-learning processes and/or models, as described in further detail below; such models may include without limitation, a training data classifier 216. Training data classifier 216 may include a classifier—such as a mathematical model, neural net, or program generated by a machine-learning algorithm such as a classification algorithm that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression, a naïve naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or a “call-when-needed” process and/or protocol: this may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process, including without limitation any process as described above and stored in memory; an input is submitted to a machine-learning model 224. Once created, machine-learning model may generate an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the “process of “training” the network, in which elements from training data 204 set are applied to the input nodes. A suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, includes algorithms that receive a training set relating a number of inputs to a number of outputs and seeks to find one or more mathematical relations relating inputs to outputs, where each of the one or more mathematical relations is optimal according to some criterion specified to the algorithm using some scoring function. For instance, a supervised learning algorithm may include a user profile, state score pair, expansion plan, walkaway plan and the like as described above as inputs, state score, state distance, a viability coaching plan and the like as outputs, and a scoring function representing a desired form of relationship to be detected between inputs and outputs. scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine a relationship between inputs and outputs. Supervised machine-learning processes may include classification algorithms, as defined above.

Further referring to FIG. 2, machine-learning processes may include at least an unsupervised machine-learning process 232. An unsupervised machine-learning process, as used herein, is a process that derives inferences in datasets without regard to labels. As a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224, using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus a term multiplying the square of each coefficient by a scalar amount to penalize large coefficients. Linear regression models may include least absolute shrinkage and selection operator (LASSO) models, in which ridge regression is combined with multiplying the least-squares term by a factor of 1, divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. A machine-learning algorithms may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization, such as variational regularization. Machine-learning algorithms may include Gaussian processes, such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

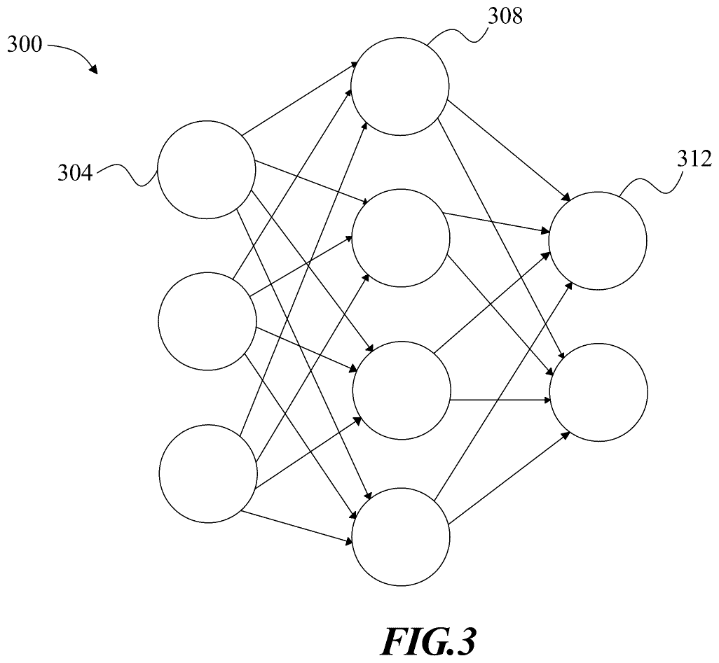

Referring now to FIG. 3, an exemplary embodiment of neural network 300 is illustrated. A neural network 300, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via a process of “training” the network, in which elements from a training dataset are applied to the input nodes. A suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

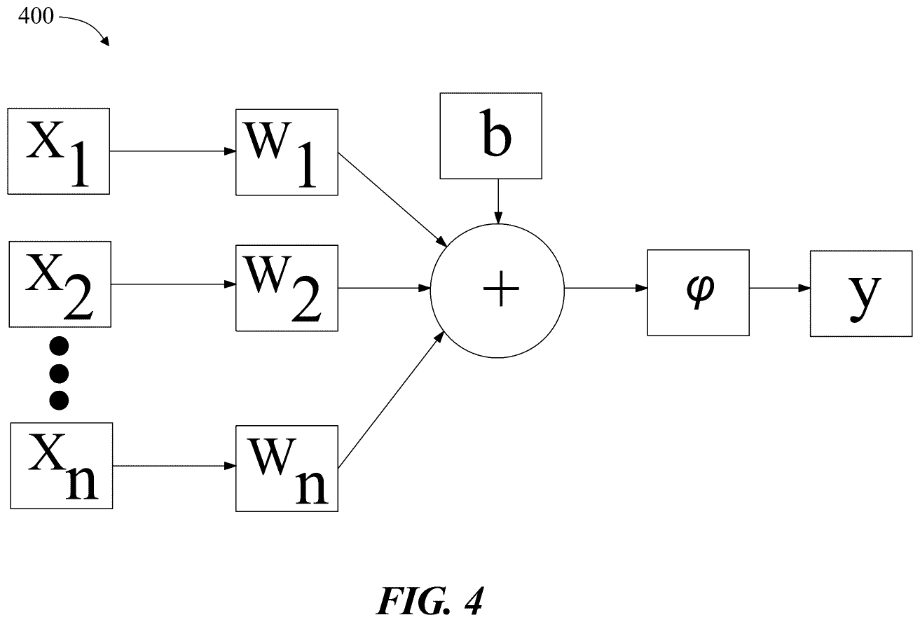

Referring now to FIG. 4, an exemplary embodiment of a node of a neural network is illustrated. A node may include, without limitation a plurality of inputs x, that may receive numerical values from inputs to a neural network containing the node and/or from other nodes. A node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or an “inhibitory,” indicating it has a weak effect influence on the one more inputs y. For instance by the corresponding weight having a small numerical value. The values of weights wi may be determined by training a neural network using training data, which may be performed using any suitable process as described above.

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as, without limitation, the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements, such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models and a predetermined class. A second fuzzy set 516, which may represent any value that may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on a probability interval, of a match between first fuzzy set 504 and second fuzzy set 516. Alternatively, or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein, with each other or with either set, which is sufficient for purposes of the matching process. For instance, threshold may indicate a sufficient degree of overlap between an output from one or more machine-learning models and/or user profiles and a predetermined class, such as, without limitation, state score categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify a user profile with a state score. For instance, if a state score has a fuzzy set matching a user profile fuzzy set by having a degree of overlap exceeding a threshold, processor 104 may classify the user profile as belonging to the state score categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, a user profile may be compared to multiple state score categorization of fuzzy sets. For instance, a user profile may be represented by a fuzzy set that is compared to each of the multiple state score categorization fuzzy sets. A degree of overlap exceeding a threshold between the user profile fuzzy set and any of the multiple state score categorization fuzzy sets may cause processor 104 to classify the user profile as belonging to state score categorization. For instance, in one embodiment, there may be two state score categorization fuzzy sets, representing, respectively, a first state score categorization and a second state score categorization. First state score categorization may have a first fuzzy set; second state score categorization may have a second fuzzy set; a user profile may also have a user profile fuzzy set. Processor 104, for example, may compare a user profile fuzzy set with each of state score categorization fuzzy sets and an instate score categorization fuzzy set, as described above, and classify a user profile to either, both, or neither of state score categorization nor instate score categorization. Machine-learning methods, as described throughout may, in a non-limiting example, generate coefficients used in fuzzy set equations as described above, such as without limitation x, c, and σ of a Gaussian set as described above, as outputs of machine-learning methods. Likewise, a user profile may be used indirectly to determine a fuzzy set. User profile fuzzy set may be derived from outputs of one or more machine-learning models that take the user profile directly or indirectly as inputs.

Still referring to FIG. 5, a computing device may use a logic comparison program—such as, but not limited to, a fuzzy logic model—to determine a state score response. A state score response may include, but is not limited to, a low state score, a medium state score, or a high state score; each such state score response may be represented as a value for a linguistic variable representing a state score response or in other words, a fuzzy set as described above that corresponds to a degree of match of state scores, as calculated using any statistical, machine-learning, or other method that may occur to a person skilled in the art upon reviewing the entirety of this disclosure. In other words, a given element of user profile may have a first non-zero value for membership in a first linguistic variable value such as a first state score and a second non-zero value for membership in a second linguistic variable value such as a second state score. In some embodiments, determining a state score categorization may include using a linear regression model. A linear regression model may include a machine-learning model. A linear regression model may be configured to map data of a user profile, such as degree of match of state scores to one or more state score parameters. A linear regression model may be trained using a machine-learning process. A linear regression model may map statistics such as, but not limited to, quality of a user profile. In some embodiments, determining a state score of a user profile may include using a state score classification model. A state score classification model may be configured to input collected data and cluster data to a centroid based on, but not limited to, frequency of appearance, linguistic indicators of quality, and the like. Centroids may include scores assigned to them, such that quality of each user profile may each be assigned a score. In some embodiments a state score classification model may include a K-means clustering model. In some embodiments, a state score classification model may include a particle swarm optimization model. In some embodiments, determining the state score of a user profile may include using a fuzzy inference engine. A fuzzy inference engine may be configured to map one or more user profile data elements, using fuzzy logic. In some embodiments, a user profile may be arranged by a logic comparison program into state score arrangements. A “state score arrangement,” as used in this disclosure is any grouping of objects and/or data based on skill level and/or output score. This step may be implemented as described above in FIGS. 1-4. Membership function coefficients and/or constants, as described above, may be tuned according to classification and/or clustering algorithms. For instance, and without limitation, a clustering algorithm may determine a Gaussian or other distribution of questions about a centroid corresponding to a given state score level and an iterative or other method may be used to find a membership function for any membership function type as described above that minimizes an average error from the statistically-determined distribution—for instance, example, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to a user profile—such as a degree of match of an element, while a second membership function may indicate a degree of in-state score of a subject thereof, or another measurable value pertaining to user profile. Continuing the example, an output linguistic variable may represent, without limitation, a score value. An inference engine may combine rules, such as: “if the amount of user-related data is “high” and the quality of user profile is “high,” the state score is “high.” The degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity; ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and an identity element of 0. Alternatively, or additionally T-conorm may be approximated by a sum, as in a “product-sum” inference engine in which T-norm is a product and T-conorm is sum. A final output score or other fuzzy inference output may be determined from an output membership function, as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

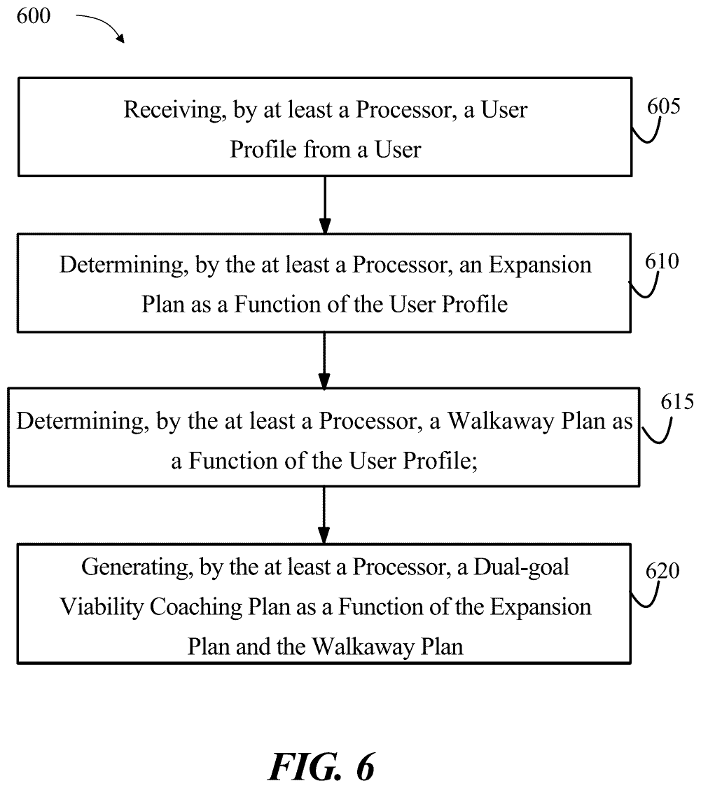

Referring now to FIG. 6, an exemplary method 600 for generating a viability coaching plan is illustrated. Method 600 includes a step 605 of receiving, by at least a processor and a user profile from a user, without limitation, as described above in reference to FIGS. 1-5. In some embodiments, step 605 of receiving the viability data may include accepting a viability assessment from the user. In some embodiments, a viability assessment may include a plurality of stages, wherein the plurality of stages may include a now stage and a goal stage. This may be implemented, without limitation, as described above in reference to FIGS. 1-5.

With continued reference to FIG. 6, method 600 further includes a step 610 of determining, by at least a processor, an expansion plan as a function of the user profile, without limitation, as described above in reference to FIGS. 1-5. In some embodiments, the expansion plan may include a plurality of expansion mindsets associated with a plurality of state scores. This may be implemented, without limitation, as described above in reference to FIGS. 1-5.

With continued reference to FIG. 6, method 600 further includes a step 615 of determining, by the at least a processor, a walkaway plan as a function of the user profile, without limitation, as described above in reference to FIGS. 1-5. In some embodiments, a walkaway plan may include a plurality of walkaway mindsets associated with a plurality of state scores. This may be implemented, without limitation, as described above in reference to FIGS. 1-5.

With continued reference to FIG. 6, method 600 further includes a step 620 of generating, by the at least a processor, a viability coaching plan as a function of the expansion plan and the walkaway plan, without limitation, as described above in reference to FIGS. 1-5. In some embodiments, a viability coaching plan may include a viability coaching step. In some embodiments, a viability coaching plan may include a viability graph. This may be implemented, without limitation, as described above in reference to FIGS. 1-5. In some embodiments, step 625 of generating a viability coaching plan may include identifying a state distance as a function of the expansion plan and the walkaway plan. In some embodiments, identifying the state distance may include comparing a current state score with a target state score. This may be implemented, without limitation, as described above in reference to FIGS. 1-5.

With continued reference to FIG. 6, method 600 may further include a step of generating, by at least a processor, a group viability model, wherein the group viability model comprises a plurality of viability coaching plans. This may be implemented, without limitation, as described above in reference to FIGS. 1-5.

It is to be noted that any one or more of the aspects and embodiments described herein may be conveniently implemented using one or more machines (e.g., one or more computing devices that are utilized as a user computing device for an electronic document or one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instructions, or portions thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

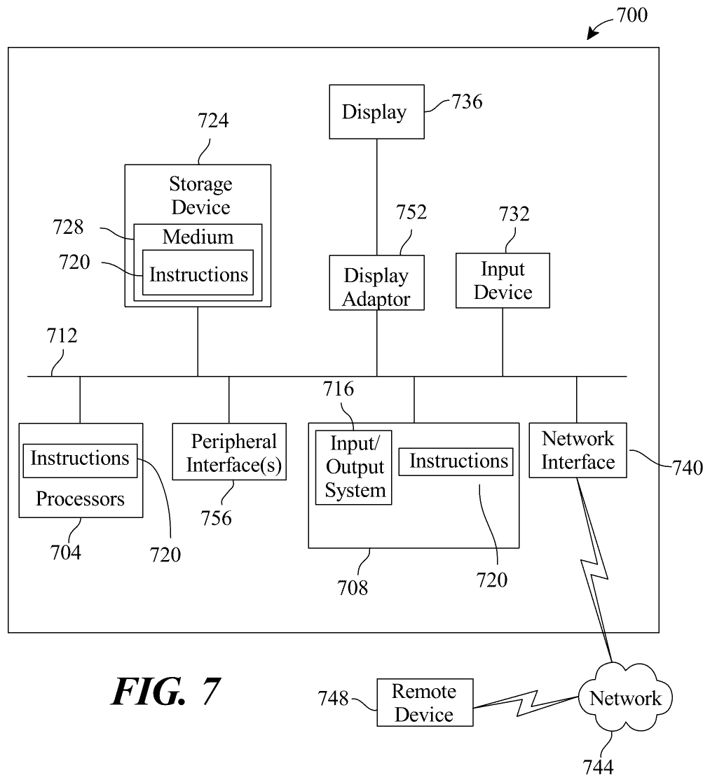

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially-configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors. Processor 704 may be organized according to Von Neumann and/or Harvard architecture, as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), an analog or mixed signal processor, a Trusted Platform Module (TPM), a floating-point unit (FPU), and/or system on a chip (SoC).

Memory 708 may include various components (e.g., machine-readable media) including, but not limited to, a random-access memory component, a read-only component, and any combinations thereof. In one example, a basic input/output system 716 (BIOS), including basic routines that help to transfer information between elements within computer system 700—such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, an advanced technology attachment (ATA), a serial ATA, a universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via an input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor-control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via a storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or another other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light-emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for generating a viability coaching plan, wherein the apparatus comprises:
at least a processor; and
a memory communicatively connected to the at least a processor, wherein the memory contains instructions configuring the at least a processor to:
receive a user profile from a user;
determine an expansion plan as a function of the user profile, wherein determining the expansion plan comprises:
determining a plurality of expansion mindsets;
receiving training data comprising a plurality of user profiles correlated to a plurality of state scores indicating a particular strength on a plurality of expansion mindsets, wherein the correlations are previously derived by the at least a processor utilizing:
a processing algorithm configured to sort unformatted training datum, wherein sorting the unformatted training datum further comprises generating categories based on correlations found in the unformatted training datum and an array indexing operation;
iteratively training a state score machine-learning model using the training data; and
outputting, using the state score machine-learning model, a plurality of state scores correlated to each expansion mindset of the expansion plan;
determine, using the state score machine-learning model, a walkaway plan as a function of the user profile; and
generate a viability coaching plan as a function of the expansion plan and the walkaway plan, wherein the viability coaching plan includes a state distance and wherein generating the state distance comprises:
iteratively training a state distance machine-learning model trained using state distance training data wherein iteratively training the state distance machine learning model using the state distance training data comprises:
applying a weighted value to an input layer of nodes comprising at least a plurality of state score pairs, an intermediate layer of nodes, and an output layer of nodes comprising at least a plurality of state distances;
adjusting one or more connections and the one or more weights between nodes in adjacent layers of the state distance machine learning model to produce the state distance;
generate a group viability model configured to provide a group insight, wherein the group insight comprises a viability coaching step for the state distance within the viability coaching plan for each group member and wherein the group viability model comprises a plurality of viability coaching plans and a comparison matrix, wherein the comparison matrix includes elements comprising state scores of each group member; and
identifying weaknesses and strengths among group members as a function of the state scores of each group member.

2. The apparatus of claim 1, wherein receiving the user profile comprises:
accepting a viability assessment from the user, wherein the viability assessment comprises a plurality of questions in a plurality of categories.

3. The apparatus of claim 2, wherein the viability assessment comprises a plurality of stages comprising a now stage and a goal stage.

4. (canceled)

5. The apparatus of claim 1, wherein the walkaway plan comprises the plurality of walkaway mindsets associated with the plurality of state scores.

6. The apparatus of claim 1, wherein the viability coaching plan comprises a viability coaching step.

7. The apparatus of claim 1, wherein the viability coaching plan comprises a viability graph displaying the plurality of state scores.

8. The apparatus of claim 1, wherein generating the viability coaching plan comprises identifying the state distance as a function of the expansion plan or the walkaway plan.

9. The apparatus of claim 8, wherein identifying the state distance comprises comparing a current state score with a target state score.

10. (canceled)

11. A method for generating a viability coaching plan, wherein the method comprises:
receiving, by at least a processor, a user profile from a user;
determining, by the at least a processor, an expansion plan as a function of the user profile, wherein determining the expansion plan comprises:
determining a plurality of expansion mindsets;
receiving training data comprising a plurality of user profiles correlated to a plurality of state scores indicating a particular strength on a plurality of expansion mindsets, wherein the correlations are previously derived by the processor utilizing:
a processing algorithm configured to sort unformatted training datum, wherein sorting the unformatted training datum further comprises generating categories based on correlations found in the unformatted training datum and an array indexing operation;
iteratively training a state score machine-learning model using the training data; and
outputting, using the state score machine-learning model, a plurality of state scores correlated to each expansion mindset of the expansion plan;
determining, using the state score machine-learning model, by the at least a processor, a walkaway plan as a function of the user profile; and
generating, by the at least a processor, a viability coaching plan as a function of the expansion plan and the walkaway plan, wherein the viability coaching plan includes a state distance and wherein generating the state distance comprises:
iteratively training a state distance machine-learning model trained using state distance training data wherein iteratively training the state distance machine learning model using the state distance training data comprises:
applying a weighted value to an input layer of nodes comprising at least a plurality of state score pairs, an intermediate layer of nodes, and an output layer of nodes comprising at least a plurality of state distances;
adjusting one or more connections and the one or more weights between nodes in adjacent layers of the state distance machine learning model to produce the state distance;
generating, by the at least a processor, a group viability model configured to provide a group insight, wherein the group insight comprises a viability coaching step for the state distance within the viability coaching plan for each group member and wherein the group viability model comprises a plurality of viability coaching plans and a comparison matrix, wherein the comparison matrix includes elements comprising state scores of each group member; and
identifying weaknesses and strengths among group members as a function of the state scores of each group member.

12. The method of claim 11, wherein receiving the user profile comprises accepting a viability assessment from the user, wherein the viability assessment comprises a plurality of questions in a plurality of categories.

13. The method of claim 12, wherein the viability assessment comprises a plurality of stages comprising a now stage and a goal stage.

14. (canceled)

15. The method of claim 11, wherein the walkaway plan comprises the plurality of walkaway mindsets associated with the plurality of state scores.

16. The method of claim 11, wherein the viability coaching plan comprises a viability coaching step.

17. The method of claim 11, wherein the viability coaching plan comprises a viability graph displaying the plurality of state scores.

18. The method of claim 11, wherein generating the viability coaching plan comprises identifying the state distance as a function of the expansion plan or the walkaway plan.

19. The method of claim 18, wherein identifying the state distance comprises comparing a current state score with a target state score.

20. (canceled)
